(19) United States
(12) Patent Application Publication
(10) Pub. No.: US 2025/0274974 A1
(43) Pub. Date: Aug. 28, 2025

(54) FUSION OF DOWNLINK AND UPLINK BASED RADIO FREQUENCY SENSING

(71) Applicant: QUALCOMM Incorporated, San Diego, CA (US)

(72) Inventors: Weimin DUAN, San Diego, CA (US); Kangqi LIU, San Diego, CA (US); Shijun WU, San Diego, CA (US)

(21) Appl. No.: 18/584,221

(22) Filed: Feb. 22, 2024

(51) Int. Cl. H04W 74/0808; H04B 17/318; H04B 17/336; H04W 24/10

(52) U.S. Cl. CPC H04W 74/0808; H04B 17/328; H04B 17/336; H04W 24/10

(57) ABSTRACT

Techniques are provided for allocating RF sensing resources for bistatic RF sensing operations in wireless networks. An example method for configuring bistatic radio frequency sensing operations according to the disclosure includes receiving radio frequency sensing information from a plurality of wireless nodes, determining a target location based at least in part on the radio frequency sensing information, determining a bistatic radio frequency sensing resource allocation based at least in part on the target location and a location of at least one of the plurality of wireless nodes, and providing radio frequency sensing resource information to the plurality of wireless nodes based on the bistatic radio frequency sensing resource allocation.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communication (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

5G enables the utilization of radio frequency (RF) signals for wireless communication between network nodes, such as base stations, user equipment (UEs), vehicles, factory automation machinery, and the like. However, the RF signals may also be used for RF sensing applications such as autonomous driving, intruder detection, gesture recognition, object detection and tracking, beam management, and other macro and micro sensing applications. Wireless local area networks may also be configured to perform RF sensing operations. RF sensing may include monostatic and bistatic implementation. Bistatic operations may require additional signaling overhead to coordinate detection and tracking operations.

### SUMMARY

An example method for configuring bistatic radio frequency sensing operations according to the disclosure includes receiving radio frequency sensing information from a plurality of wireless nodes, determining a target location based at least in part on the radio frequency sensing information, determining a bistatic radio frequency sensing resource allocation based at least in part on the target location and a location of at least one of the plurality of wireless nodes, and providing radio frequency sensing resource information to the plurality of wireless nodes based on the bistatic radio frequency sensing resource allocation.

An example apparatus according to the disclosure includes at least one memory, at least one transceiver, and at least one processor communicatively coupled to the at least one memory and the at least one transceiver, and configured to: receive radio frequency sensing information from a plurality of wireless nodes, determine target parameters based at least in part on the radio frequency sensing information, determine a bistatic radio frequency sensing resource allocation based at least in part on the target parameters and a range to at least one of the plurality of wireless nodes, and provide radio frequency sensing resource information to the plurality of wireless nodes based on the bistatic radio frequency sensing resource allocation.

Items and/or techniques described herein may provide one or more of the following capabilities, as well as other capabilities not mentioned. A wireless node may be capable of transmitting and/or receiving radio frequency (RF) sensing signals. The wireless node may utilize the same receivers for both communications and RF sensing operations. The wireless node may be configured to perform monostatic and bistatic RF sensing. A networked server may be configured to allocate RF sensing resources for uplink (UL) and downlink (DL) sensing operations. The server may be configured to adapt the UL and DL resource allocation based on target distributions. The percentages of UL and DL RF sensing resources may vary based on the relative locations of targets and wireless nodes. The server may be configured to fuse UL and DL RF sensing measurements to enhance target detection. One or more machine learning models may be implemented to enhance target detection based on UL and DL RF sensing measurements. RF sensing measurement reports may be scaled to accommodate increased signaling overhead associated with bistatic RF sensing operations. Other capabilities may be provided and not every implementation according to the disclosure must provide any, let alone all, of the capabilities discussed.

### BRIEF DESCRIPTION OF THE DRAWINGS

FIG. 1 illustrates an example wireless communications system.

FIGS. 2A and 2B illustrate example wireless network structures.

FIGS. 3A to 3C are simplified block diagrams of several sample components that may be employed in wireless communication nodes and configured to support communication and radio frequency sensing.

FIG. 4A illustrates an example monostatic RF sensing system.

FIG. 4B illustrates an example bistatic RF sensing system.

FIG. 5 is an example graph showing a radio frequency (RF) channel response over time.

FIG. 6 includes block diagrams of a prior art orthogonal frequency-division multiplexing (OFDM) transmitter and receiver for performing RF sensing.

FIGS. 7A and 7B are diagrams of example adaptive uplink (UL) and downlink (DL) RF sensing operations.

FIGS. 8A-8C are diagrams of example bistatic RF sensing resource allocations for adaptive UL and DL RF sensing operations.

FIG. 9 is an example process flow for allocating RF sensing resources.

FIG. 10 is an example machine learning (ML) based fusion of DL and UL RF sensing measurements.

FIGS. 11A and 11B is an example RF sensing use case including fusing UL and DL RF sensing signals.

FIG. 12 is an example message flow diagram for configuring UL and DL RF sensing signals.

FIG. 13 is an example process flow diagram of a method for configuring bistatic RF sensing operations.

### DETAILED DESCRIPTION

Techniques are provided herein for allocating RF sensing resources for bistatic RF sensing operations in wireless networks. In general, RF sensing may be regarded as consumer-level radar with advanced detection capabilities. For example, RF sensing may be used in applications such as health monitoring (e.g., heartbeat detection, respiration rate monitoring, etc.), gesture recognition (e.g., human activity recognition, keystroke detection, sign language recognition), contextual information acquisition (e.g., location detection/tracking, direction finding, range estimation), automotive radar (e.g., smart cruise control, collision avoidance) and the like.

In monostatic RF sensing operations, a wireless node such as a base station or a mobile device (e.g., a user equipment (UE)) may be configured to transmit RF sensing signals and then measure echo signals from targets based on those RF sensing signals. The hardware required for monostatic RF sensing may be cost prohibitive in some markets. The hardware associated with bistatic RF sensing may be relatively lower and hence may find wide adoption in some markets. In bistatic RF sensing operations, a first wireless node may transmit RF sensing signals, and a second wireless node may receive those RF sensing signals and/or echoes of those signals caused by proximate targets. In wireless networks with several wireless nodes, a network entity such as a server may be configured to allocate frequency domain and time domain resources for bistatic operations and to disseminate RF sensing resource information to the wireless nodes in the network.

In an example, base stations and mobile devices may be configured to perform bistatic RF sensing. A downlink (DL) RF sensing resource may be a RF signal transmitted by a base station such that one or more mobile devices may be configured to measure the RF signal and the potential echoes caused by proximate targets. Conversely, an uplink (UL) RF sensing resource may be a RF signal transmitted by a mobile device such that the potential echoes are received by one or more base stations. As used herein, the terms UL and DL are not limited to exchanges between base stations and mobile devices. Other wireless nodes may be configured to perform as either a base station or a mobile device, and the terms UL and DL may generally be used to describe two use cases when one wireless node is transmitting or receiving RF sensing signals. For example, in device-to-device (D2D) communications between two mobile devices, the transmissions from a first mobile device may be considered DL transmissions, and transmissions from a second mobile device may be considered UL transmissions.

In operation, a wireless node may detect a proximate object with a higher signal to noise ratio (SNR) when a target is closer to the wireless node as compared to when the target is further from the wireless node. For example, when a target is closer to a UE when a base station transmits a DL RF sensing resource, the UE may receive the echo signals from the target at a higher SNR as compared to an echo signal generated when the target is close to the base station. Conversely, when a UE transmits a UL RF sensing resource, a base station may receive the echo signals from a proximate target at a higher SNR as compared to echo signals generated when the target is close to the UE. The techniques provided herein provide for adaptive DL and UL RF sensing resource allocation in an network schedule scheme based on target location distribution. For example, when a target is close to a base station, a higher percentage of UL RF sensing resources may be allocated. When a target is close to a mobile device (e.g., UE), a higher percentage of DL RF sensing resources may be allocated. When targets are approximately midway between stations, a balance of UL and DL RF sensing resources may be allocated, and a network resource may be configured to fuse the corresponding UL and DL RF sensing measurements reported by the respective wireless nodes. The fusion of DL and UL RF sensing measurements may enhance the sensing performance of the network. As used herein, the term fusion refers to the process of combining information from multiple sensors or sources to enhance the overall accuracy and reliability of a system. For example, by combining measurements obtained from multiple wireless nodes, a network resource (e.g., sensing server) may realize improved target detection performance in terms of accuracy, coverage, and reliability. Measurement fusion may help compensate for the limitations and uncertainties of individual RF sensing measurements. The fusion process may include data integration, signal processing, and algorithmic combinations to determine target information based on the collective RF sensing measurement reports provided by the wireless nodes in the network. In an example, artificial intelligence and machine learning (AI/ML) techniques may be utilized to determine target information based on receiving RF sensing measurement reports from multiple wireless nodes.

Particular aspects of the subject matter described in the disclosure may be implemented to realize one or more of the following potential advantages. RF sensing target detection accuracy and tracking performance may be increased. Network allocation of RF sensing resources may reduce over-the-air (OTA) message traffic for bistatic RF sensing operations. The network scheduling scheme for RF sensing operations may be improved. AI/ML models may utilize fused UL and DL RF sensing measurements for improved target detection and tracking. Bistatic sensing may be used to augment monostatic sensing operations for high-end wireless nodes. These techniques and configurations are examples, and other techniques and configurations may be used.

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” (BS) may generally be referred to as “wireless nodes”, and are not intended to be specific or otherwise limited to any particular radio access technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (CNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference RF signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

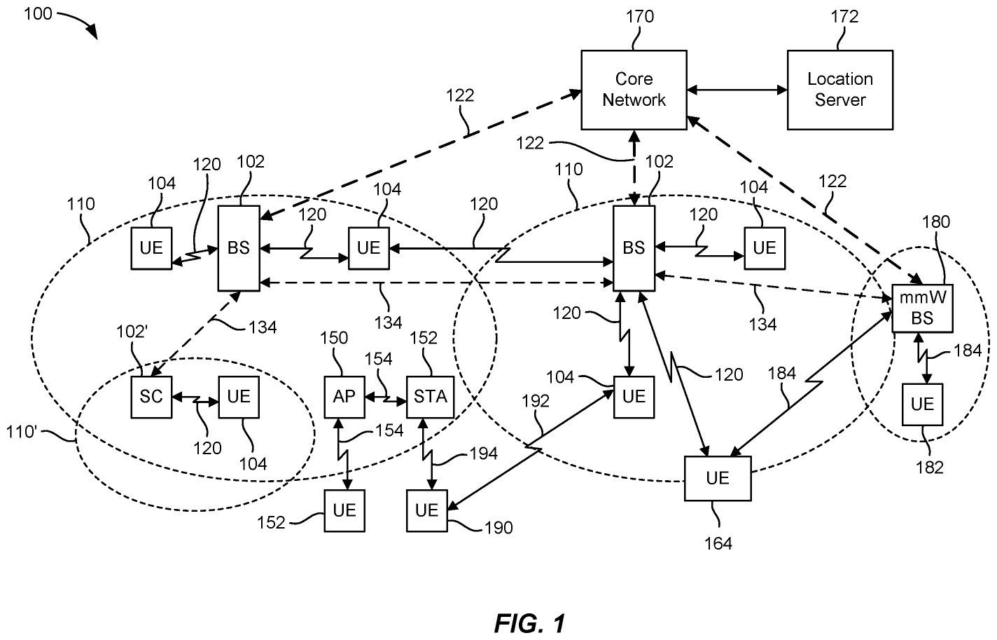

Referring to FIG. 1, an example wireless communications system 100 is shown. The wireless communications system 100 (which may also be referred to as a wireless wide area network (WWAN)) may include various base stations 102 and various UEs 104. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (cMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STA 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave.

Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas.

Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a base station. The UE can then form a transmit beam for sending one or more uplink reference signals (e.g., uplink positioning reference signals (UL-PRS), sounding reference signal (SRS), demodulation reference signals (DMRS), PTRS, etc.) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over communication links 120 and/or the mmW base station 180 over a mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

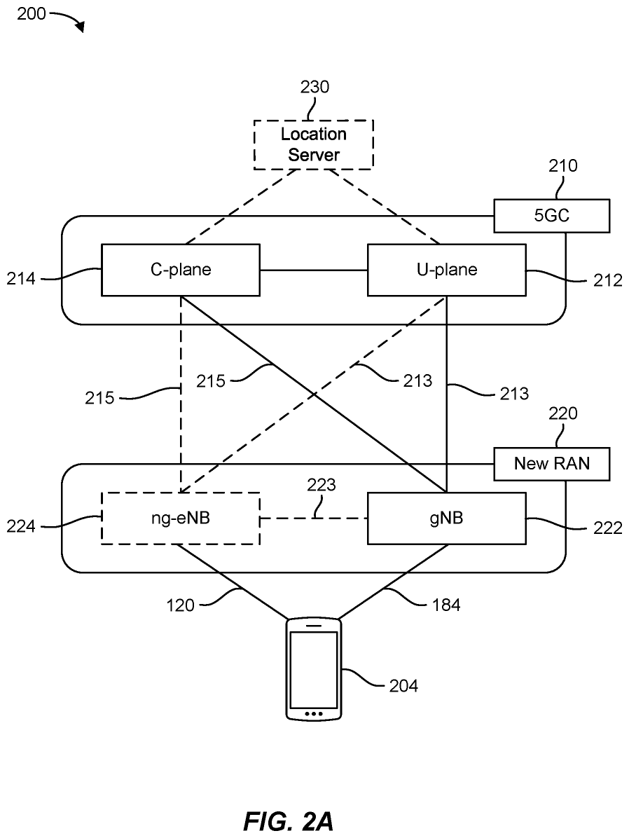

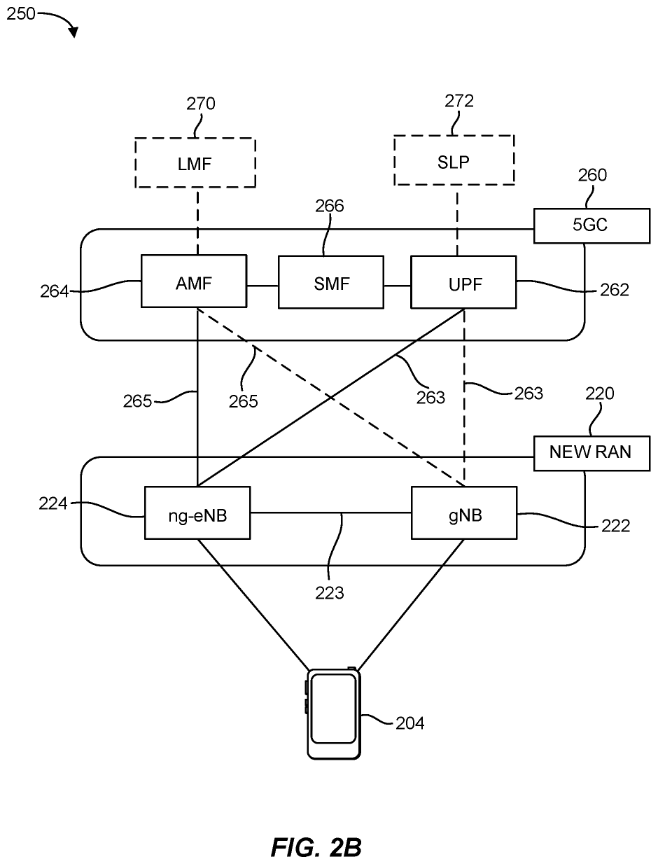

Referring to FIG. 2A, an example wireless network structure 200 is shown. For example, a 5GC 210 (also referred to as a Next Generation Core (NGC)) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the control plane functions 214 and user plane functions 212. In an additional configuration, an ng-cNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, the New RAN 220 may only have one or more gNBs 222, while other configurations include one or more of both ng-cNBs 224 and gNBs 222. Either gNB 222 or ng-eNB 224 may communicate with UEs 204 (e.g., any of the UEs depicted in FIG. 1). Another optional aspect may include location server 230, which may be in communication with the 5GC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network.

Referring to FIG. 2B, another example wireless network structure 250 is shown. For example, a 5GC 260 can be viewed functionally as control plane functions, provided by an access and mobility management function (AMF) 264, and user plane functions, provided by a user plane function (UPF) 262, which operate cooperatively to form the core network (i.e., 5GC 260). User plane interface 263 and control plane interface 265 connect the ng-cNB 224 to the 5GC 260 and specifically to UPF 262 and AMF 264, respectively. In an additional configuration, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). The base stations of the New RAN 220 communicate with the AMF 264 over the N2 interface and with the UPF 262 over the N3 interface.

The functions of the AMF 264 include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the New RAN 220 and the LMF 270, evolved packet system (EPS) bearer identifier allocation for interworking with the EPS, and UE 204 mobility event notification. In addition, the AMF 264 also supports functionalities for non-3GPP access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as a secure user plane location (SUPL) location platform (SLP) 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, New RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

In an aspect, the LMF 270 and/or the SLP 272 may be integrated into a base station, such as the gNB 222 and/or the ng-eNB 224. When integrated into the gNB 222 and/or the ng-eNB 224, the LMF 270 and/or the SLP 272 may be referred to as a “location management component,” or “LMC.” However, as used herein, references to the LMF 270 and the SLP 272 include both the case in which the LMF 270 and the SLP 272 are components of the core network (e.g., 5GC 260) and the case in which the LMF 270 and the SLP 272 are components of a base station.

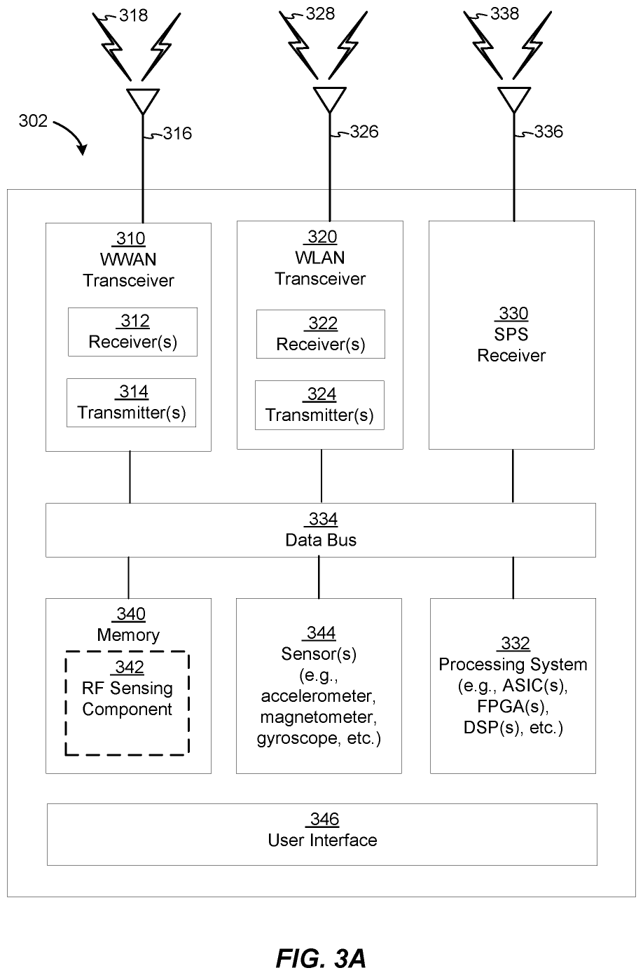

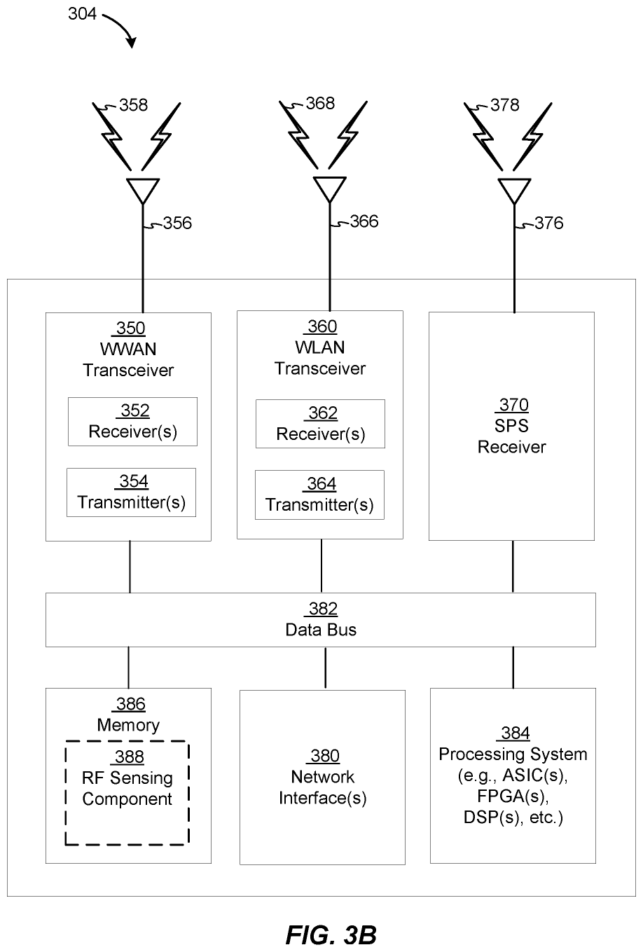

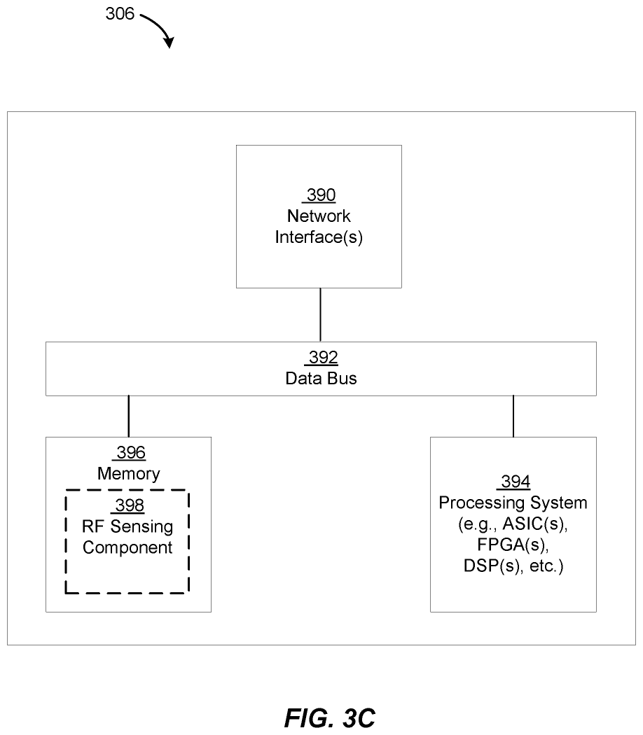

Referring to FIGS. 3A, 3B and 3C, several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270) to support the file transmission operations are shown. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include wireless wide area network (WWAN) transceiver 310 and 350, respectively, configured to communicate via one or more wireless communication networks (not shown), such as an NR network, an LTE network, a GSM network, and/or the like. The WWAN transceivers 310 and 350 may be connected to one or more antennas 316 and 356, respectively, for communicating with other network nodes, such as other UEs, access points, base stations (e.g., cNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 also include, at least in some cases, wireless local area network (WLAN) transceivers 320 and 360, respectively. The WLAN transceivers 320 and 360 may be connected to one or more antennas 326 and 366, respectively, for communicating with other network nodes, such as other UEs, access points, base stations, etc., via at least one designated RAT (e.g., WiFi, LTE-D, Bluetooth®, etc.) over a wireless communication medium of interest. The WLAN transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively.

Transceiver circuitry including at least one transmitter and at least one receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antennas 316, 326, 356, 366), such as an antenna array, that permits the respective apparatus to perform transmit “beamforming,” as described herein. Similarly, a receiver may include or be coupled to a plurality of antennas (e.g., antennas 316, 326, 356, 366), such as an antenna array, that permits the respective apparatus to perform receive beamforming, as described herein. In an aspect, the transmitter and receiver may share the same plurality of antennas (e.g., antennas 316, 326, 356, 366), such that the respective apparatus can only receive or transmit at a given time, not both at the same time. A wireless communication device (e.g., one or both of the transceivers 310 and 320 and/or 350 and 360) of the UE 302 and/or the base station 304 may also comprise a network listen module (NLM) or the like for performing various measurements.

The UE 302 and the base station 304 also include, at least in some cases, satellite positioning systems (SPS) receivers 330 and 370. The SPS receivers 330 and 370 may be connected to one or more antennas 336 and 376, respectively, for receiving SPS signals 338 and 378, respectively, such as global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. The SPS receivers 330 and 370 may comprise any suitable hardware and/or software for receiving and processing SPS signals 338 and 378, respectively. The SPS receivers 330 and 370 request information and operations as appropriate from the other systems, and performs calculations necessary to determine positions of the UE 302 and the base station 304 using measurements obtained by any suitable SPS algorithm.

The base station 304 and the network entity 306 each include at least one network interfaces 380 and 390 for communicating with other network entities. For example, the network interfaces 380 and 390 (e.g., one or more network access ports) may be configured to communicate with one or more network entities via a wire-based or wireless backhaul connection. In some aspects, the network interfaces 380 and 390 may be implemented as transceivers configured to support wire-based or wireless signal communication. This communication may involve, for example, sending and receiving messages, parameters, and/or other types of information.

The UE 302, the base station 304, and the network entity 306 also include other components that may be used in conjunction with the operations as disclosed herein. The UE 302 includes processor circuitry implementing a processing system 332 for providing functionality relating to, for example, joint communication and RF sensing (i.e., integrated sensing and communications (ISAC) operations), and for providing other processing functionality. The base station 304 includes a processing system 384 for providing functionality relating to, for example, ISAC operations as disclosed herein, and for providing other processing functionality. The network entity 306 includes a processing system 394 for providing functionality relating to, for example, ISAC operations as disclosed herein, and for providing other processing functionality. In an aspect, the processing systems 332, 384, and 394 may include, for example, one or more general purpose processors, multi-core processors, ASICs, digital signal processors (DSPs), field programmable gate arrays (FPGA), or other programmable logic devices or processing circuitry.

The UE 302, the base station 304, and the network entity 306 include memory circuitry implementing memory components 340, 386, and 396 (e.g., each including a memory device), respectively, for maintaining information (e.g., information indicative of reserved resources, thresholds, parameters, and so on). In some cases, the UE 302, the base station 304, and the network entity 306 may include RF sensing components 342, 388, and 398, respectively. The RF sensing components 342, 388, and 398 may be hardware circuits that are part of or coupled to the processing systems 332, 384, and 394, respectively, that, when executed, cause the UE 302, the base station 304, and the network entity 306 to perform the functionality described herein. In other aspects, the RF sensing components 342, 388, and 398 may be external to the processing systems 332, 384, and 394 (e.g., part of a modem processing system, integrated with another processing system, etc.). Alternatively, the RF sensing components 342, 388, and 398 may be memory modules (as shown in FIGS. 3A-C) stored in the memory components 340, 386, and 396, respectively, that, when executed by the processing systems 332, 384, and 394 (or a modem processing system, another processing system, etc.), cause the UE 302, the base station 304, and the network entity 306 to perform the functionality described herein.

The UE 302 may include one or more sensors 344 coupled to the processing system 332 to provide movement and/or orientation information that is independent of motion data derived from signals received by the WWAN transceiver 310, the WLAN transceiver 320, and/or the SPS receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in 2D and/or 3D coordinate systems.

In addition, the UE 302 includes a user interface 346 for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the processing system 384 in more detail, in the downlink, IP packets from the network entity 306 may be provided to the processing system 384. The processing system 384 may implement functionality for an RRC layer, a packet data convergence protocol (PDCP) layer, a radio link control (RLC) layer, and a medium access control (MAC) layer. The processing system 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the processing system 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the processing system 332, which implements Layer-3 and Layer-2 functionality.

In the uplink, the processing system 332 provides demultiplexing between transport and logical channels, packet reassembly, deciphering, header decompression, and control signal processing to recover IP packets from the core network. The processing system 332 is also responsible for error detection.

Similar to the functionality described in connection with the downlink transmission by the base station 304, the processing system 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the processing system 384.

In the uplink, the processing system 384 provides demultiplexing between transport and logical channels, packet reassembly, deciphering, header decompression, control signal processing to recover IP packets from the UE 302. IP packets from the processing system 384 may be provided to the core network. The processing system 384 is also responsible for error detection.

For convenience, the UE 302, the base station 304, and/or the network entity 306 are shown in FIGS. 3A-C as including various components that may be configured according to the various examples described herein. It will be appreciated, however, that the illustrated blocks may have different functionality in different designs.

The various components of the UE 302, the base station 304, and the network entity 306 may communicate with each other over data buses 334, 382, and 392, respectively. The components of FIGS. 3A-C may be implemented in various ways. In some implementations, the components of FIGS. 3A-C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by components 310 to 346 may be implemented by processor and memory component(s) of the UE 302 (e.g., by execution of appropriate code and/or by appropriate configuration of processor components). Similarly, some or all of the functionality represented by components 350 to 388 may be implemented by processor and memory component(s) of the base station 304 (e.g., by execution of appropriate code and/or by appropriate configuration of processor components). Also, some or all of the functionality represented by components 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a positioning entity,” etc. However, as will be appreciated, such operations, acts, and/or functions may actually be performed by specific components or combinations of components of the UE, base station, positioning entity, etc., such as the processing systems 332, 384, 394, the transceivers 310, 320, 350, and 360, the memory components 340, 386, and 396, the RF sensing components 342, 388, and 398, etc.

Wireless communication signals (e.g., RF signals configured to carry OFDM symbols) transmitted between a UE and a base station can be reused for environment sensing (also referred to as “RF sensing” or “radar”). Using wireless communication signals for environment sensing can be regarded as consumer-level radar with advanced detection capabilities that enable, among other things, touchless/device-free interaction with a device/system. The wireless communication signals may be cellular communication signals, such as LTE or NR signals, WLAN signals, etc. As a particular example, the wireless communication signals may be an OFDM waveform as utilized in LTE and NR. High-frequency communication signals, such as mmW RF signals, are especially beneficial to use as radar signals because the higher frequency provides, at least, more accurate range (distance) detection.

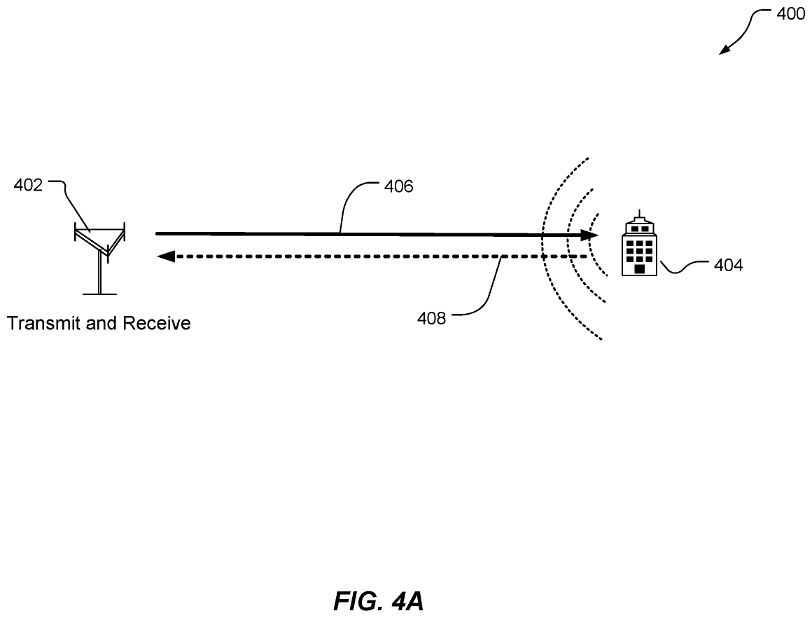

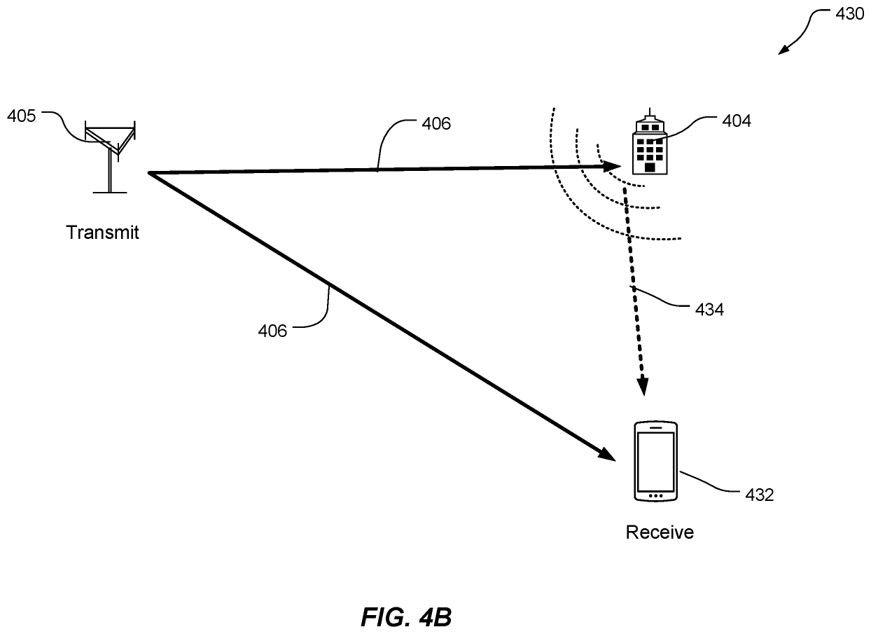

In general, there are different types of RF sensing, and in particular, monostatic and bistatic (e.g., multistatic) RF sensing. FIGS. 4A and 4B illustrate two of these various types of RF sensing. Specifically, FIG. 4A is a diagram 400 illustrating a monostatic RF sensing scenario, and FIG. 4B is a diagram 430 illustrating a bistatic RF sensing scenario. The concepts of the bistatic RF sensing scenario in FIG. 4B may be extended to multiple stations for multistatic RF sensing. In FIG. 4A, a base station 402 may be configured for full duplex operation and thus the transmitter (Tx) and receiver (Rx) are co-located. For example, a transmitted radio frequency (RF) signal 406 may be reflected off of a target object, such as a building 404, and the receiver on the base station 402 is configured to receive and measure a reflected beam 408. This is a typical use case for traditional, or conventional, RF sensing. In an example, monostatic RF sensing may be realized with half duplex operation such that a transceiver may be configured to transmit a RF sensing signal at a first time, and then receive a reflected signal at a second time. In FIG. 4B, a base station 405 may be configured as a transmitter (Tx) and a UE 432 may be configured as a receiver (Rx). In this example, the transmitter and the receiver are not co-located, that is, they are separated. The base station 405 may be configured to transmit a beam, such as an omnidirectional downlink RF signal which may be received by the UE 432. A portion of the RF signal 406 may be reflected or refracted by the building 404 and the UE 432 may receive this reflected signal 434. This is the typical use case for wireless communication-based (e.g., WiFi-based, LTE-based, NR-based) RF sensing. Note that while FIG. 4B illustrates using a downlink RF signal 406 as a RF sensing signal, uplink RF signals can also be used as RF sensing signals. In a downlink scenario, as shown, the transmitter is the base station 405 and the receiver is the UE 432, whereas in an uplink scenario, the transmitter is a UE and the receiver is a base station.

Referring to FIG. 4B in greater detail, the base station 405 transmits RF sensing signals (e.g., OFDM reference signals or other waveforms) to the UE 432, but some of the RF sensing signals reflect off a target object such as the building 404. The UE 432 can measure the ToAs of the RF signal 406 received directly from the base station, and the ToAs of the reflected signal 434 which is reflected from the target object (e.g., the building 404).

The base station 405 may be configured to transmit the single RF signal 406 or multiple RF signals to a receiver (e.g., the UE 432). However, the UE 432 may receive multiple RF signals corresponding to each transmitted RF signal due to the propagation characteristics of RF signals through multipath channels. Each path may be associated with a cluster of one or more channel taps. Generally, the time at which the receiver detects the first cluster of channel taps is considered the ToA of the RF signal on the line-of-site (LOS) path (i.e., the shortest path between the transmitter and the receiver). Later clusters of channel taps are considered to have reflected off objects between the transmitter and the receiver and therefore to have followed non-LOS (NLOS) paths between the transmitter and the receiver.

Thus, referring back to FIG. 4B, the RF signal 406 follows a LOS path between the base station 405 and the UE 432, and the reflected signal 434 represents the RF sensing signals that followed a NLOS path between the base station 405 and the UE 432 due to reflecting off the building 404 (or another target object). The base station 405 may have transmitted multiple RF sensing signals (not shown in FIG. 4B), some of which followed the LOS path and others of which followed the NLOS path.

Alternatively, the base station 405 may have transmitted a single RF sensing signal in a broad enough beam that a portion of the RF sensing signal followed the LOS path and a portion of the RF sensing signal followed the NLOS path.

Based on the difference between the ToA of the LOS path, the ToA of the NLOS path, and the speed of light, the UE 432 can determine the distance to the building 404. In addition, if the UE 432 is capable of receive-beam forming, the UE 432 may be able to determine the general direction to the building 404 as the direction of the reflected signal 434, which is the RF sensing signal following the NLOS path as received. The UE 432 may then optionally report this information to the transmitting base station 405, an application server associated with the core network, an external client, a third-party application, or some other entity. Alternatively, the UE 432 may report the ToA measurements to the base station 405, or other entity, and the base station 405 may determine the distance and, optionally, the direction to the target object.

Note that if the RF sensing signals are uplink RF signals transmitted by the UE 432 to the base station 405, the base station 405 may be configured to perform object detection based on the uplink RF signals just like the UE 432 does based on the downlink RF signals.

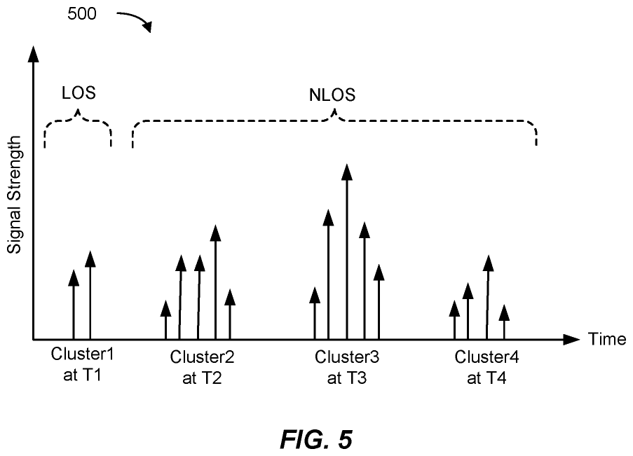

Referring to FIG. 5, an example graph 500 showing an RF channel response at a receiver (e.g., any of the UEs or base stations described herein) over time is shown. In the example of FIG. 5, the receiver receives multiple (four) clusters of channel taps. Each channel tap represents a multipath that an RF signal followed between the transmitter (e.g., any of the UEs or base stations described herein) and the receiver. That is, a channel tap represents the arrival of an RF signal on a multipath. Each cluster of channel taps indicates that the corresponding multipaths followed essentially the same path. There may be different clusters due to the RF signal being transmitted on different transmit beams (and therefore at different angles), or because of the propagation characteristics of RF signals (potentially following widely different paths due to reflections), or both.

Under the channel illustrated in FIG. 5, the receiver receives a first cluster of two RF signals on channel taps at time T1, a second cluster of five RF signals on channel taps at time T2, a third cluster of five RF signals on channel taps at time T3, and a fourth cluster of four RF signals on channel taps at time T4. In the example of FIG. 5, because the first cluster of RF signals at time T1 arrives first, it is presumed to be the LOS data stream (i.e., the data stream arriving over the LOS or the shortest path), and may correspond to the LOS path illustrated in FIG. 4B (e.g., the RF signal 406). The third cluster at time T3 is comprised of the strongest RF signals, and may correspond to the NLOS path illustrated in FIG. 4B (e.g., the reflected signal 434). Note that although FIG. 5 illustrates clusters of two to five channel taps, as will be appreciated, the clusters may have more or fewer than the illustrated number of channel taps.

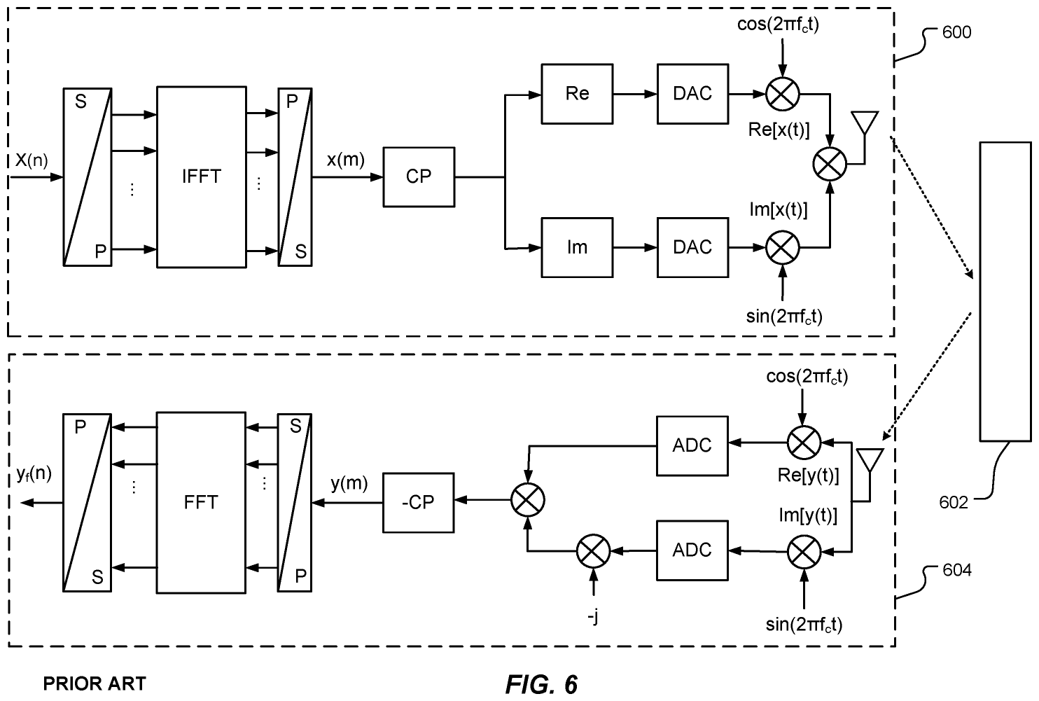

Referring to FIG. 6, block diagrams of a prior art OFDM transmitter 600 and receiver 604 are shown. FIG. 6 is an example of an ISAC capable OFDM transmitter 600 and receiver 604 that may be employed by the example wireless communication nodes described herein. The OFDM transmitter 600 is configured to transmit OFDM signals which may be used for communications and RF sensing operations. OFDM symbols may be generated via Inverse Fast Fourier Transform (IFFT) and shifted into the RF band via quadrature modulation and transmitted over the channel, which may include one or more objects 602. The receiver 604 may receive reflected signals and remove the cyclic prefix (CP) from the quadrature demodulated signal. Complex modulation symbols may be obtained via the FFT. The received waveform may be demodulated based on spectral division, which cancels out the transmitted complex modulation symbols by elementwise multiplication. This 2D-FFT processing enables distance-velocity RF sensing that is similar to frequency modulated continuous wave (FMCW) based radar systems. In an example, the transmitter 600 and the receiver 604 may be in the same wireless node and may be configured for monostatic RF sensing. The transmitter 600 and the receiver 604 may be in different wireless nodes and may be utilized for bistatic RF sensing operations.

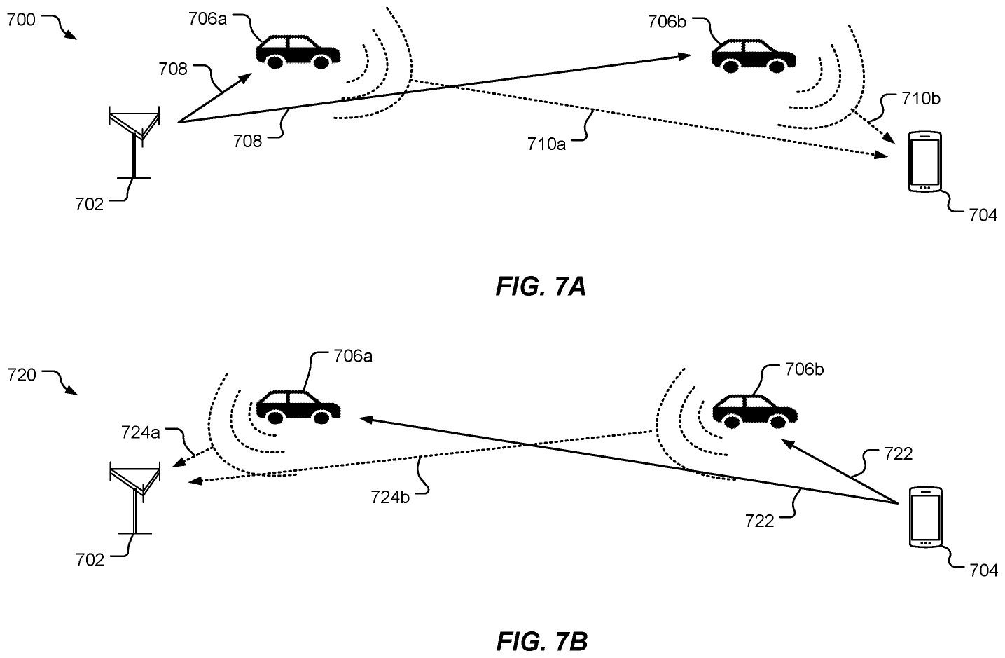

Referring to FIGS. 7A and 7B, diagrams of example adaptive UL and DL RF sensing operations are shown. The first diagram 700 includes a base station 702 and a UE 704. The base station 702 may include some or all of the components of a base station 304, and the base station 304 is an example the base station 702. The UE 704 may include some or all the components of the UE 302, and the UE 302 is an example of the UE 704. The base station 702 may be configured to transmit RF sensing signals 708, and the UE 704 is configured to receive echoes from the RF sensing signals 708. A first vehicle 706a is located close to the base station 702, and a second vehicle 706b is located closer to the UE 704. The first vehicle 706a causes a first DL echo signal 710a to be received by the UE 704, and the second vehicle 706b causes a second DL echo signal 710b to be received by the UE 704. In operation, the SNR for the second DL echo signal 710b may be higher than the SNR for the first DL echo signal 710a.

In a second diagram 720, the UE 704 is configured to transmit uplink RF sensing signals 722, and the base station 702 is configured to receive corresponding echo signals. For example, a first UL echo signal 724a may be caused by the first vehicle 706a, and a second UL echo signal 724b may be caused by the second vehicle 706b. The SNR of the first UL echo signal 724a may be higher than the SNR of the second UL echo signal 724b. The diagrams 700, 720 suggest that when a first station (e.g., the base station 702) transmits DL RF sensing signals, a second station (e.g., the UE 704) may have more confidence in near-object sensing (e.g., the second vehicle 706b) and may deemphasize far range targets (e.g., the first vehicle 706a). For example, the UE 704 may determine to ignore the first vehicle 706a to conserve battery and processing power. Conversely, when the second station transmits UL RF sensing signals, the first station may have more confidence in proximate targets (e.g., closer to the first station than the second station).

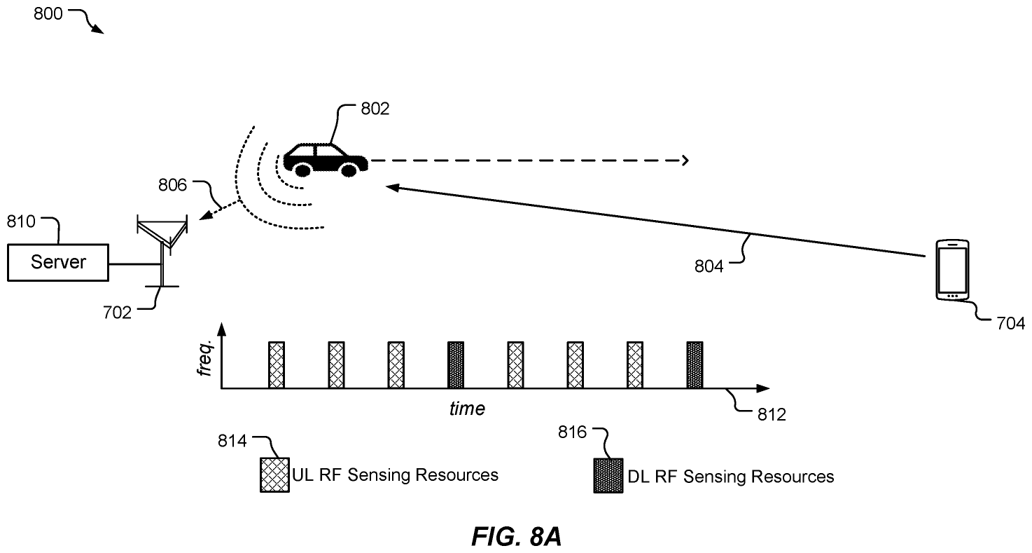

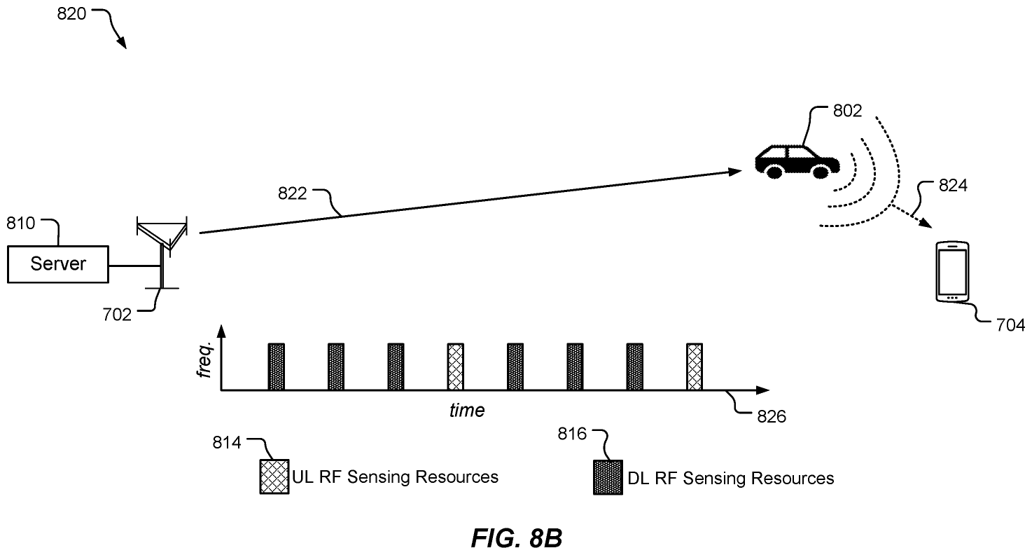

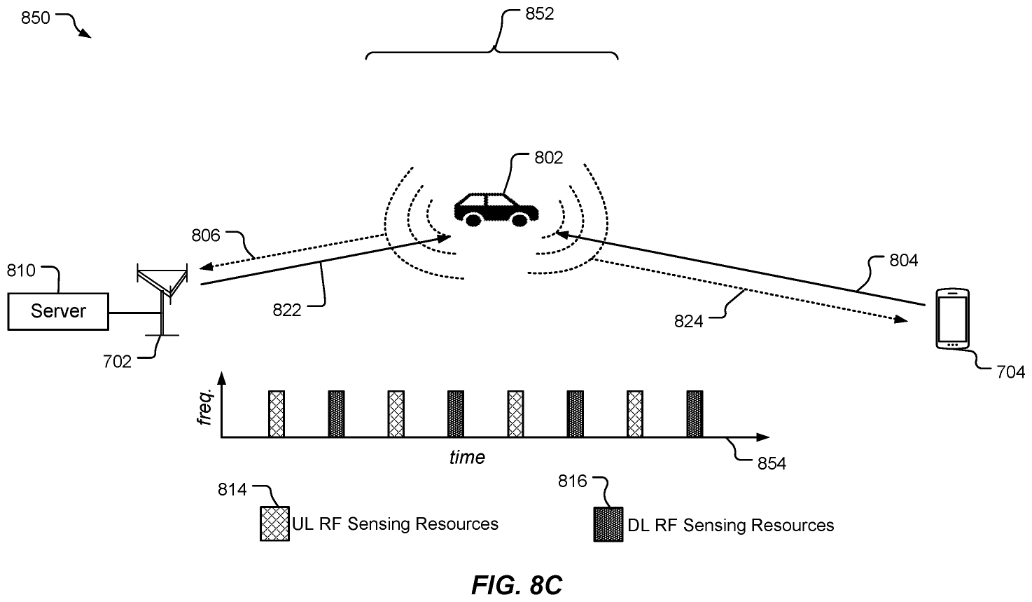

Referring to FIGS. 8A-8C, with further reference to FIGS. 7A-7B, diagrams of example bistatic RF sensing resource allocation for adaptive UL and DL RF sensing signals are shown. The diagrams include the base station 702 the UE 704, a target vehicle 802, and a sensing server 810. The sensing server 810 may include some or all of the components of the network entity 306, and the network entity 306 is an example of the sensing server 810. The sensing server 810 may be in communication with the base station 702 and the UE 704 (e.g., via a wireless network, such as the wireless communication system 100 or other local area network), and may be configured to schedule/allocate time/frequency resources to enable RF sensing operations. For example, the sensing server 810 may be configured to generate assistance data including RF sensing resources (e.g., time, frequency, waveform and other information to enable stations to transmit and receive RF sensing signals) and to provide the assistance data to the wireless nodes in a network. In a first diagram 800, the base station 702 and the UE 704 may be configured to utilize UL and DL RF sensing resources during a scan phase to initially detect the target vehicle 802. The base station 702 and the UE 704 may be configured to report RF sensing measurements to the sensing server 810. The sensing server 810 may be configured to determine that the target vehicle 802 is relatively closer to the base station 702 than the UE 704 (e.g., as depicted in FIG. 8A) and may be configured to adapt the RF sensing resources such that a higher percentage of the RF sensing resources are UL RF sensing resources. A first example RF sensing resource allocation plan 812 includes more UL RF sensing resources 814 than DL RF sensing resources 816. Various network signaling techniques may be used to inform the base station 702 and the UE 704 of the RF sensing resource allocation plan 812. In response to receiving the RF sensing resource allocation plan 812, the UE 704 may be configured to transmit one or more UL RF sensing signals 804, and the base station 702 may be configured to receive one or more UL echo signals 806 caused by the target vehicle 802.

Referring to FIG. 8B, in a second diagram 820, the target vehicle 802 has moved closer to the UE 704. The sensing server 810 is configured to adapt the RF sensing resources to increase the percentage of DL RF sensing resources 816 in a second example RF sensing resource allocation plan 826. The base station 702 may be configured to transmit DL RF sensing signals 822 and the UE 704 may be configured to receive DL echo signals 824 caused by the target vehicle 802.

Referring to FIG. 8C, in a third diagram 850, the target vehicle 802 may be in a region 852 which is approximately halfway between the base station 702 an the UE 704. In this use case, the sensing server 810 may configure a third example RF sensing resource allocation plan 854 which may have a balance of UL RF sensing resources 814 and DL RF sensing resources 816. The balance of RF sensing resources may be biased based on the location of the target vehicle relative to the locations of the base station 702 and the UE 704 (e.g., more UL RF sensing resources 814 when the target vehicle 802 is closer to the base station 702, and more DL RF sensing resources 816 when the target vehicle 802 is closer to the UE 704).

The single target vehicle in FIGS. 8A-8C is an example to describe the concept of adaptive UL and DL RF sensing resource allocation. In operation, the allocations may be based on a distribution of multiple targets amongst several base stations and/or mobile devices. In this use case, if a distribution of targets is random across an area (e.g., a cell), the sensing server 810 may be configured to balance the DL and UL RS sensing resources. The sensing server 810 may be configured to dynamically allocate RF sensing resources since the distribution of the targets in an area may change dynamically, especially for high mobility targets. The signaling of RF sensing resource allocation plans may utilize techniques that are similar to mobility and positioning protocols, but with some refinements to reduce the overall signaling overhead. In an example, assistance data including RF sensing resource allocations may be delivered via System Information Blocks (SIBs) or Radio Resource Control (RRC) messaging, and may include multiple RF sensing resource configurations. Lower level messaging, such as Downlink Control Information (DCI) and/or Medium Access Control (MAC) Control Element (CE) signaling may be utilized to dynamically switch between different RF sensing resource configurations. In an example, a wireless node (e.g., base station 702, UE 704), and the sensing server 810 may be configured to send and receive on-demand requests for DL and/or UL RF sensing resources. In an example, the RF sensing resource configurations may be different Time Division Duplex (TDD) patterns to implicitly switch between different percentages of DL or UL RF sensing resources. For example, a UE may be expected to skip DL reception or UL transmission due to collisions between previously configured reference signals for DL or UL RF sensing.

DCI based dynamic Slot Formation Indicators (SFI) may be used to indicate when a station may skip reception and/or transmission of respective DL and UL RF sensing signals. Other signaling technologies may also be used.

In general, when compared with messaging that is associated with mobility and positioning operations, the signaling associated with RF sensing measurements may be further scaled based on the number of targets. Target dense areas may cause a significant increase in messaging, which may increase the required signaling overhead. The techniques provided herein may reduce the amount of signaling for RF sensing operations while maintaining an expected quality of service for RF sensing operations. In an example, the wireless nodes (e.g., base station 702, UE 704) may be configured to report a fixed number (e.g., ‘x’) of measurements (e.g., the first ‘x’ measurements). For example, if the measurement is a channel impulse response (CIR) or carrier-to-error rate (CER), the wireless nodes may be configured to report the first ‘x’ taps, where the line of sight (LOS) path is treated as the reference tap. In an example, if the RF sensing measurement is per target based, the wireless nodes may be configured to report only ‘x’ targets with minimum ranges (e.g., based on threshold values established by the sensing server 810).

In an example, the RF sensing measurement reports may be down selected based on the SNR or RSRP of the measurement. A wireless node may be configured to report ‘x’ targets or taps (if it is a CIR/CER based measurement) with the largest ‘x’ SNR or RSRP values. The wireless nodes may be configured to report the associated SNR/RSRP. The RF sensing measurements may be down selected based on a confidence a wireless node has in the measurements. For example, a wireless node may be configured to estimate a confidence of the RF sensing measurement, and then select and report the ‘x’ targets or taps (if it is CIR/CER based measurement) with the highest confidence. The wireless node may be configured to report the associated confidence level. In an example, the confidence level may be based on SNR/RSRP and/or other RF and non-RF measurements associated with the RF sensing measurements. For example, other RF sensing measurements such as clutter measurements, Doppler distribution, etc. may be used.

In operation, the value of ‘x’ may be included in RF sensing allocation or configuration information and may be established by a network entity as a compromise between the demands on signaling overhead and the quality or scope of sensing coverage. For example, if ‘x’ is larger, the sensing coverage may be larger, but the signaling overhead may increase. The sensing server 810 may be configured to determine values for ‘x’ based on the locations of the wireless nodes and the target density. The value of ‘x’ may be specific for a wireless node and dynamic based on the wireless node's location. In an example, the value of ‘x’ may be based on AI/ML models utilizing wireless node locations and target density information along with other training data such as network traffic and available overhead for OTA messaging.

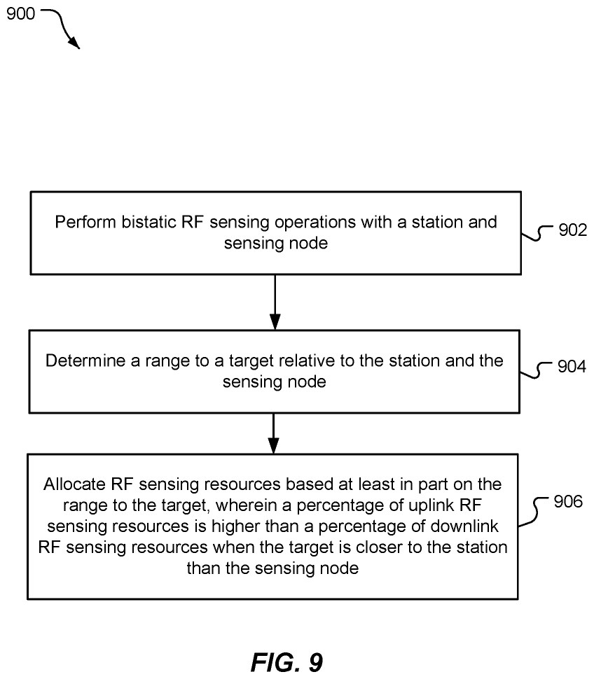

Referring to FIG. 9, an example process 900 for allocating RF sensing resources includes the stages shown. A network entity 306, such as the sensing server 810, or other wireless nodes described herein, may be configured to allocate RF sensing resources. The process 900 is, however, an example and not limiting. The process 900 may be altered, e.g., by having stages added, removed, rearranged, combined, performed concurrently, and/or having single stages split into multiple stages.

At stage 902, the process includes performing bistatic RF sensing operations with a station and a sensing node. A network entity 306, including the processing system 394 and the network interface 390, is a means for performing bistatic RF sensing operations. In an example, referring to FIGS. 8A-8C, the sensing server 810 may be configured to receive RF sensing report messages from the base station 702 and the UE 704. In this example, the station is the base station 702 and the sensing node is the UE 704. Other wireless nodes may be used as the respective station and sensing node. The bistatic RF sensing operations may include UL RF sensing signals 804 transmitted by the UE 704 with UL echo signals 806 received by the base station 702, and DL RF sensing signals 822 transmitted by the base station 702 with DL echo signals 824 received by the UE 704. Measurement reports based on the respective echo signals 806, 824 may be provided to the sensing server 810 via network communication protocols such as LPP, RCC, PUSCH, PUCCH, and other messaging techniques.

At stage 904, the process includes determining a range to a target relative to the station and the sensing node. The network entity 306, including the processing system 394 and the network interface 390, is a means for determining the range to the target. In an example, the sensing server 810 may be configured to determine an initial range to the target vehicle 802 based on the RF sensing measurement reports provided by the base station 702 and the UE 704, and other stations in the network. For example, the station and/or the sensing node may be configured to report a range and/or other parameters and echo information (e.g., SNR, RSRP, CIR, CER, etc.) to the target to the sensing server 810. Other RF sensing information may be reported and the sensing server 810 may be configured to determine the range to the target (e.g., based on the locations of the station and the sensing nodes and the reported RF sensing information).

At stage 906, the process includes allocating RF sensing resources based at least in part on the range to the target, wherein a percentage of uplink RF sensing resources is higher than a percentage of downlink RF sensing resources when the target is closer to the station than the sensing node. The network entity 306, including the processing system 394 and the network interface 390, is a means for allocating RF sensing resources. In an example, referring to FIG. 8A, the sensing server 810 may be configured to determine that the target vehicle 802 is relatively closer to the station (e.g., the base station 702) than the sensing node (e.g., the UE 704) and may be configured to adapt the RF sensing resources such that a higher percentage of the RF sensing resources are UL RF sensing resources. A first example RF sensing resource allocation plan 812 includes more UL RF sensing resources 814 than DL RF sensing resources 816. In another example, referring to FIG. 8B, the sensing server 810 may be configured to determine or receive information indicating the target vehicle 802 has moved closer to the UE 704, and then adapt the RF sensing resources to increase the percentage of DL RF sensing resources 816 in a second example RF sensing resource allocation plan 826.

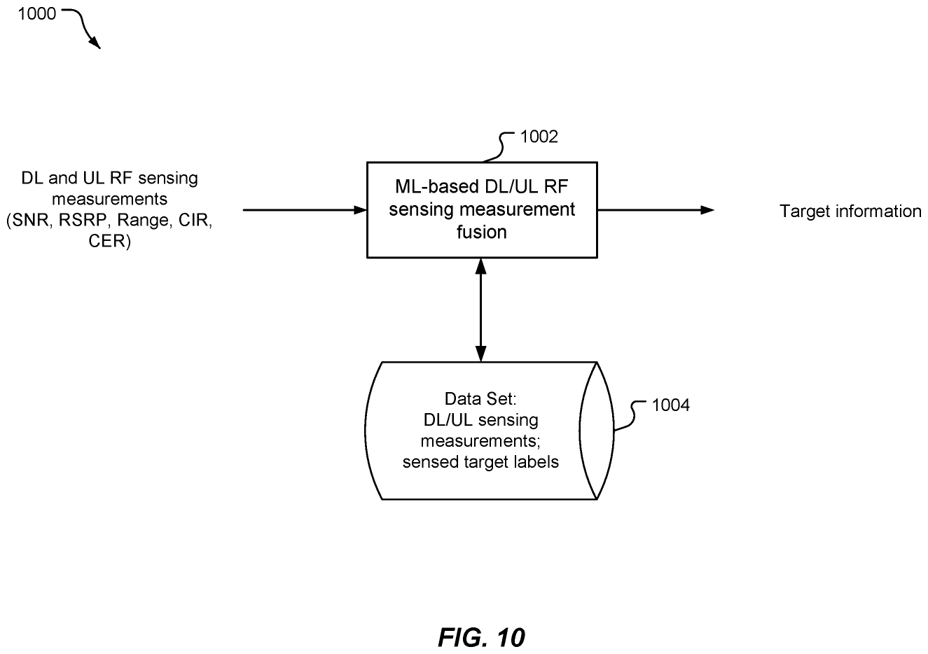

Referring to FIG. 10, an example machine learning (ML) based DL and UL RF sensing measurement fusion module 1000 are shown. A ML based DL/UL RF sensing measurement fusion model 1002 may be trained to learn relationships between DL and UL RF sensing measurements to predict target information such as range and potentially target identification information based on combinations of DL and/or UL RF sensing measurements. Additional data may also be used with the model 1002. For example, a data set 1004 may also include DL/UL sensing measurements and sensed target labels. The sensed target labels may be parameters associated with the object such as the location, coarse location, speed, radar cross section (RCS), size, material, shape, etc. The DL/UL RF sensing measurements and sensed target labels may be obtained by a wireless nodes and reported to a network entity (e.g., sensing server, gNB). These measurements may be added to the data set 1004 as training data that may be used to train (or re-train) the ML based DL/UL RF sensing measurement fusion model 1002. In an example, the size of the data set 1004 may be very large, and it may not be feasible to share the entire dataset with a mobile device, such as a UE 302. In some cases, rather than share the data set 1004, a more practical approach may be to train the DL/UL RF sensing measurement fusion model 1002 as a neural network (NN) using the data set 1004, and then share the neural network model and the parameters (e.g., weights and the like) for the trained model with mobile devices. The mobile devices may then use the trained NN to predict target information based on DL and UL RF sensing measurements (e.g., SNR, RSRP, Range, CIR, CER, etc.). The sensed target labels may also be used as inputs to the NN.

Such a machine learning model may be trained using various techniques to learn how to predict target information based on DL and UL sensing measurements, and optionally, the sensed target label information. Given an input of DL and UL RF sensing measurements for a target reported to a network entity (e.g., the sensing server 810), the trained machine learning model may be configured to fuse the DL and UL RF sensing measurements and output target information.

In an example, the DL/UL RF sensing measurement fusion model 1002 may be trained using supervised learning techniques in which an input data set of a plurality of DL and UL RF sensing measurements may be used to train the machine learning model to recognize relationships based on a fusion of the DL/UL measurements (and optional sensed target labels) and associated target information. The model 1002 may be trained to output target information.

The DL/UL RF sensing measurement fusion model 1002 may be trained offline and deployed to a sensing node for use in predicting target information based on a fusing DL and UL sensing measurements. The DL/UL RF sensing measurement fusion model 1002 may be based on other machine learning algorithms and training methods. For example, supervised learning algorithms, unsupervised learning algorithms, reinforcement learning algorithms, deep learning algorithms, artificial neural network algorithms, or other type of machine learning algorithms may be used. For example, the machine learning may be performed using a deep convolutional network (DCN). DCNs are networks of convolutional networks, configured with additional pooling and normalization layers. DCNs have achieved state-of-the-art performance on many tasks. DCNs may be trained using supervised learning in which both the input and output targets are known for many examples and are used to modify the weights of the network by use of gradient descent methods. DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

In an example, the machine learning may be performed using a neural network. Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

In an example, different types of artificial neural networks may be used to implement machine learning, such as recurrent neural networks (RNNs), multilayer perceptron (MLP) neural networks, convolutional neural networks (CNNs), and the like. RNNs work on the principle of saving the output of a layer and feeding this output back to the input to help in predicting an outcome of the layer. In MLP neural networks, data may be fed into an input layer, and one or more hidden layers provide levels of abstraction to the data. Predictions may then be made on an output layer based on the abstracted data. MLPs may be particularly suitable for classification prediction problems where inputs are assigned a class or label. Convolutional neural networks (CNNs) are a type of feed-forward artificial neural network. Convolutional neural networks may include collections of artificial neurons that each has a receptive field (e.g., a spatially localized region of an input space) and that collectively tile an input space. Convolutional neural networks may be trained to recognize a hierarchy of features. Computation in convolutional neural network architectures may be distributed over a population of processing nodes, which may be configured in one or more computational chains. These multi-layered architectures may be trained one layer at a time and may be fine-tuned using back propagation.

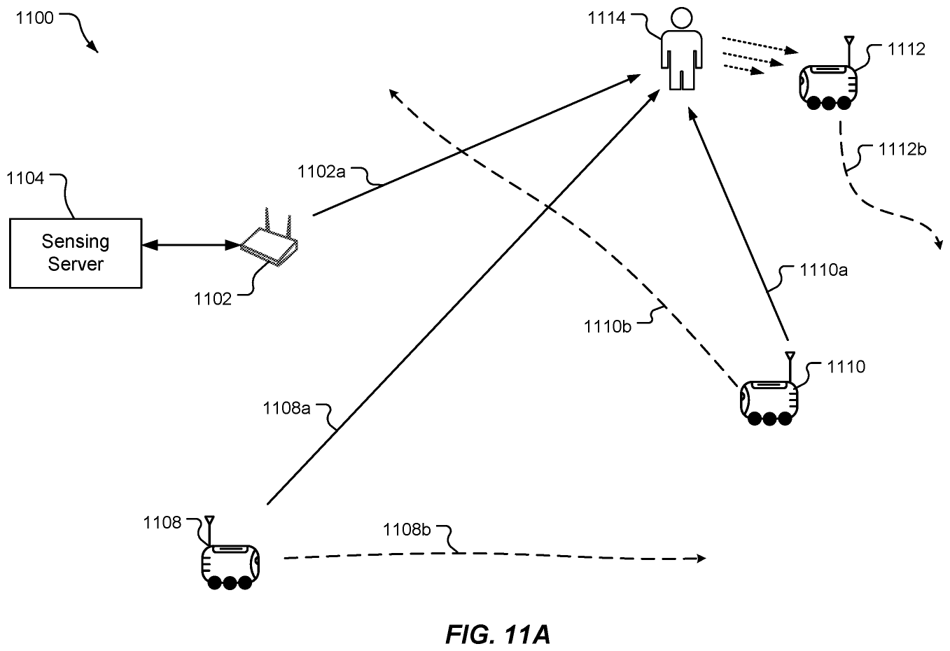

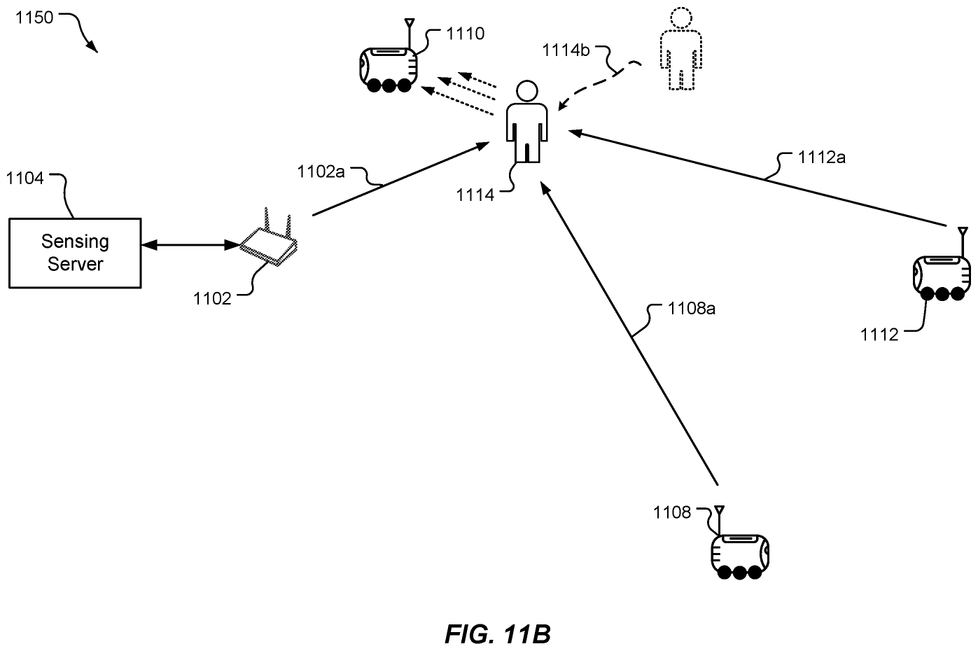

Referring to FIGS. 11A and 11B, an example, RF sensing use case including fusing UL and DL RF sensing signals is shown. The use case in FIGS. 11A and 11B may be an indoor RF sensing use case, such as on a factory floor, office space, or other areas covered by a wireless local area network (WLAN) where humans and automated vehicles may be in proximity to one another. A first diagram 1100 depicts the use case at a first time and includes an access point (AP) 1102, sensing server 1104, and a plurality of automated vehicles configured to utilize bistatic RF sensing to detect objects such as a person 1114. The plurality of automated vehicles includes a first vehicle 1108, a second vehicle 1110, and a third vehicle 1112. Each of the vehicles 1108, 1110, 1112 and the AP 1102 are configured to communicate with the sensing server 1104 and may provide RF sensing measurement reports and/or receive RF sensing resource configuration information to/from the sensing server 1104 via wired and wireless technologies such as WiFi, NR sidelink, BTE, UWB, and other D2D protocols. The sensing server 1104 may be tracking the location of the person 1114 and may allocate RF sensing resources for the AP 1102 and vehicles 1108, 1110, 1112 to transmit and receive DL and UL RF sensing signals. Since the person 1114 is currently proximate to the third vehicle 1112, the sensing server may allocate a higher percentage of DL RF sensing signals 1102a from the AP 1102 and UL RF sensing signals 1108a, 1110a from the respective first and second vehicles 1108, 1110. The third vehicle 1112 may utilize the echo signals caused by the person 1114 to determine the target information associated with the person 1114 (e.g., range, speed, direction, etc.). The vehicles 1108, 1110, 1112 are mobile and may proceed along example trajectories 1108b, 1110b, 1112b, respectively. The person 1114 may also move and the sensing server 1104 may be configured to dynamically modify the RF sensing resources based on the changing relative locations (e.g., ranges) between the AP 1102, the vehicles 1108, 1110, 1112, and the person 1114.

Referring to FIG. 11B, a second diagram 1150 illustrates the vehicles 1108. 1110, 1112 after they have followed the respective trajectories 1108b, 1110b, 1112b. The person 1114 also moved along a trajectory 1114b. The sensing server 1104 may determine that the person 1114 is now located proximate to the second vehicle 1110 and may allocate RF sensing resources such that the AP 1102 transmits a higher percentage of DL RF sensing signals 1102a, and the first and third vehicles 1108, 1112 transmit a higher percentage of respective UL RF sensing signals 1108a, 1112a. The second vehicle 1110 may receive the associated echo signals and provide measurement reports to the sensing server 1104 (e.g., via the AP 1102). The number of APs and vehicles in the use case are examples, and not limitations. The sensing server 1104 may be configured to allocate RF sensing resources based on a plurality of persons and wireless nodes based on the proximity strategy as described in FIGS. 7A-11B. Further, the sensing server 1104 may utilize UL and DL measurement fusion when the targets are midway between stations (e.g., as depicted in FIG. 8C) to enhance RF sensing performance. AI/ML models may be used to generate target information based on the combinations of UL and DL RF sensing measurements. In an example, the bistatic sensing operations described in FIGS. 11A and 11B may be combined with monostatic sensing operations and the sensing server 1104 may be configured to allocate RF sensing resources to enable the wireless nodes to perform monostatic sensing.

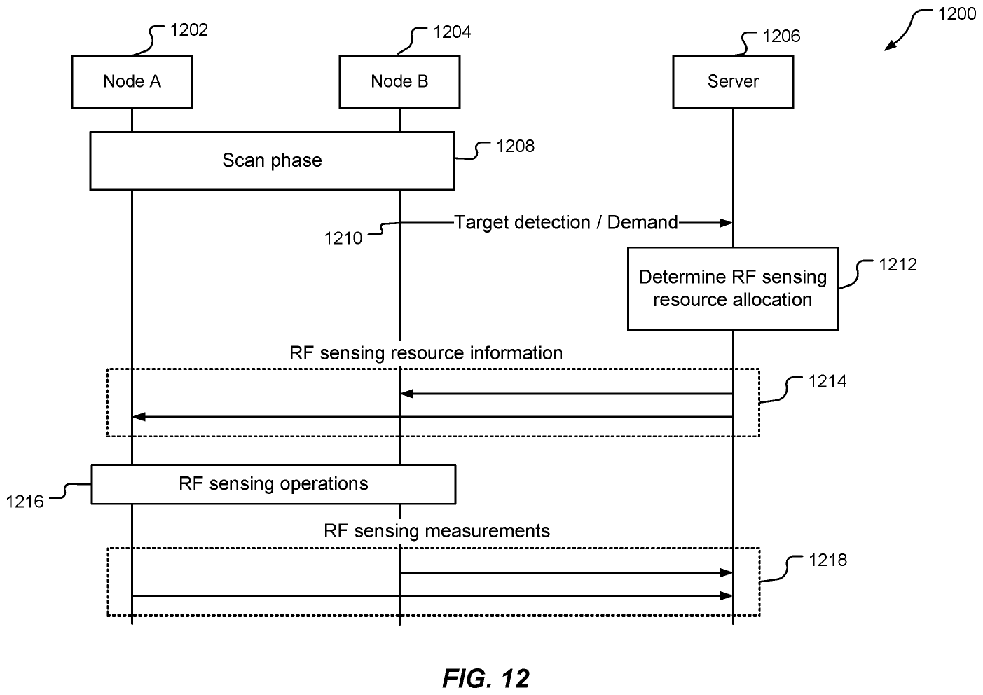

Referring to FIG. 12, an example message flow 1200 for configuring UL and DL RF sensing signals is shown. The message flow 1200 includes a plurality of wireless nodes and a sensing server, such as a first wireless node 1202, a second wireless node 1204, and a server 1206. In an example, the first wireless node 1202 may be a UE and may have some or all of the components of the UE 302, and the UE 302 may be an example of the first wireless node 1202. The second wireless node 1204 may be a base station and may have some or all of the components of the base station 304, and the base station 304 may be an example of the second wireless node 1204. The server 1206 may have some or all of the components of the network entity 306, and the network entity 306 may be an example of the server 1206. The message flow 1200 may be utilized with different combinations of wireless nodes (e.g., UEs, gNB, AP, femto cells, pico cells, etc.) and the context of UL and DL channels between different combinations of stations may also be different.

In operation, the message flow 1200 may be implemented to scan and track targets utilizing bistatic RF sensing with the wireless nodes. At stage 1208, the wireless nodes 1202, 1204 may transmit respective UL and DL RF sensing signals and receive corresponding echo signals as described in FIGS. 7A and 7B. One or more of the wireless nodes 1202, 1204 may provide target detection report messages 1210 to the server 1206. In an example, the target detection report messages 1210 may include an on-demand request for bistatic RF sensing. At stage 1212, the server 1206 may be configured to determine RF sensing resource allocations based at least in part on the target detection report messages 1210. In an example, the server 1206 may utilize one or more AI/ML models with a fusion of the UL and DL measurement information (e.g., as described in FIG. 10) to determine target information, and then allocate the RF sensing resources based on the target information. In an example, the server 1206 may determine that a target is relatively closer to the first wireless node 1202 than the second wireless node 1204, and then allocate the RF sensing resources such that a higher percentage of the RF sensing resources are RF sensing resources transmitted by the second wireless node 1204. In another example, the server 1206 may determine that a target is relatively closer to the second wireless node 1204 than the first wireless node 1202, and then allocate the RF sensing resources to increase the percentage of the RF sensing resources that are transmitted by the first wireless node 1202. In an example, the server 1206 may determine that one or more targets are approximately in the middle of the wireless nodes 1202, 1204 and may allocate a balance of RF resources such that RF sensing signals transmitted by the wireless nodes 1202, 1204 are approximately equal.

The server 1206 may be configured to provide RF sensing resource information 1214 to the wireless nodes 1202, 1204. In an example, RF sensing resource information 1214 may be assistance data including RF sensing resource allocations and may be delivered via SIB and/or RRC messaging. The RF sensing resource information 1214 may include multiple RF sensing resource configurations and lower level messaging (e.g., DCI, MAC-CE) may be utilized to dynamically switch between different RF sensing resource configurations. In an example, the RF sensing resource information may include TDD patterns to implicitly switch between different percentages of DL or UL RF sensing resources. For example, one of the wireless nodes 1202, 1204 may be configured (e.g., via SFI) to skip DL reception or UL transmission due to collisions between previously configured reference signals for DL or UL RF sensing.

At stage 1216, the wireless nodes 1202, 1204 may be configured to perform RF sensing operations based at least in part on the RF sensing resource information 1214 provided by the server 1206. The RF sensing resource information 1214 may include frequency domain and time domain resource allocations, as well as RF sensing waveform and identification information to enable the wireless nodes 1202, 1204 to perform RF sensing operations in a network. The wireless nodes 1202, 1204 may be configured to send one or more RF sensing measurement report messages 1218 to the server 1206, and/or to other network resources. For example, when devices are utilizing D2D services (e.g., NR Sidelink) one of the devices may be configured as a sensing server and may be configured to receive measurement reports from other wireless nodes. The measurement information may include target range computations, and/or other RF indicators and non-RF indicators associated with targets such as CIR, CER, SNR, RSRP, Doppler distribution, clutter measurements, etc. In an example, in an effort to reduce the signaling overhead for RF sensing operations, the wireless nodes 1202, 1204 may be configured to report a fixed number (e.g., ‘x’) of measurements (e.g., the first ‘x’ measurements, the first ‘x’ taps, only ‘x’ targets with minimum ranges, etc.). In an example, the RF sensing measurement report messages 1218 may be down selected based on the SNR or RSRP of the measurements. Other information may also be included in the RF sensing measurement report messages 1218 which may assist the server 1206 in allocating future RF sensing resources. In an example, RF sensing measurement report messages 1218 may be used to train one or more AI/ML models and/or determine whether an existing model may require updating (e.g., utilized by model life cycle management (LCM) processes).

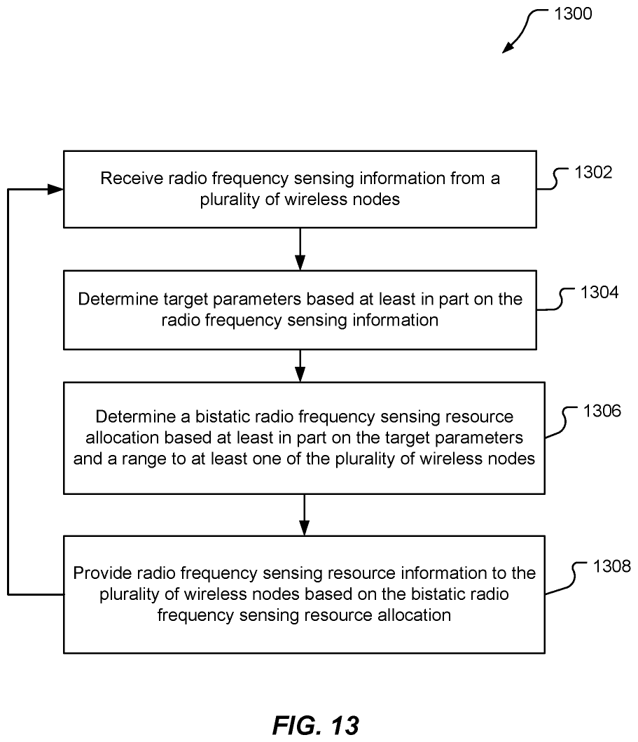

Referring to FIG. 13, with further reference to FIGS. 1-12, a method 1300 for configuring bistatic RF sensing operations includes the stages shown. A network entity 306, such as the server 1206, or other wireless nodes described herein, may be configured to allocate RF sensing resources. The method 1300 is, however, an example and not limiting. The method 1300 may be altered, e.g., by having stages added, removed, rearranged, combined, performed concurrently, and/or having single stages split into multiple stages. For example, wireless node capability information and on-demand requests (not shown in FIG. 13) may be used to configure bistatic RF sensing operations.

At stage 1302, the method includes receiving radio frequency sensing information from a plurality of wireless nodes. The network entity 306, including the processing system 394 and the network interface 390, is a means for receiving RF sensing information. In an example, the RF sensing information may include RF and non-RF information associated with RF sensing signals (e.g., echo signals) received by the plurality of wireless nodes. The RF information and non-RF information may include CIR, CER, SNR, RSRP, Doppler distribution, clutter measurements, and other RF measurements. The RF sensing information may be based on monostatic and/or bistatic sensing operations. In an example, the RF sensing information may include an on-demand request from a wireless node to initiate and/or modify RF sensing resource allocation. The RF sensing information may include capabilities information indicating the hardware and/or software capabilities of a wireless node to participate in RF sensing operations.

At stage 1304, the method includes determining target parameters based at least in part on the radio frequency sensing information. The network entity 306, including the processing system 394 and the network interface 390, is a means for determining the target parameters. In an example, the RF sensing information received at stage 1302 may include range and/or location information associated with targets and detected by the wireless nodes. The RF sensing information may include RF signal information associated with a plurality of taps received by the respective wireless nodes. The server 1206 may be configured to determine the ToAs for LOS and NLOS signals to determine a distance to a target. Other signal processing techniques may be used to determine target locations based on the RF measurements obtained by the wireless nodes. For example, one or more AI/ML models, such as described in FIG. 10, may be used to predict target locations based on the RF sensing information. In an example, the RF sensing information received at stage 1302 may be based on a fusion of UL and DL sensing measurements. The target parameters may be one or more of a per target SNR based fusion, a per target RSRP based fusion, a per target range-based fusion, and a CIR based fusion (e.g., by combining the DL and UL CIR or CER). In an example, the network entity 306 may be configured to fuse RF sensing information received from the plurality of wireless nodes.

At stage 1306, the method includes determining a bistatic radio frequency sensing resource allocation based at least in part on the target parameters and a range to at least one of the plurality of wireless nodes. The network entity 306, including the processing system 394 and the network interface 390, is a means for determining the bistatic RF sensing resource allocation. The network entity 306 may be configured to utilize one or more AI/ML models with a fusion of the UL and DL measurement information included in the RF sensing information to determine target information, and then allocate the RF sensing resources based on the target information. In an example, the network entity 306 may determine that a target is relatively closer to a first wireless node of the plurality of wireless nodes, and then allocate the RF sensing resources such that a higher percentage of the RF sensing resources are RF sensing resources transmitted by other wireless nodes. In another example, the network entity 306 may determine that a target is relatively closer to another wireless node rather than the first wireless node, and then allocate the RF sensing resources to increase the percentage of the RF sensing resources are transmitted by the first wireless node. In an example, the network entity 306 may determine that one or more targets are approximately in the middle of two or more of the plurality of wireless nodes and may allocate a balance of RF resources such that RF sensing signals transmitted by two or more of the wireless nodes are approximately equal. Other RF sensing resource allocation schemes may also be used based on the relative locations of the targets and the wireless nodes.

At stage 1308, the method includes providing radio frequency sensing resource information to the plurality of wireless nodes based on the bistatic radio frequency sensing resource allocation. The network entity 306, including the processing system 394 and the network interface 390, is a means for providing the RF sensing resource information to the plurality of nodes. In an example, the network entity 306 may be configured to provide the RF sensing resource information to the plurality of wireless nodes as assistance data including the RF sensing resource allocations. The assistance data may be delivered via SIB and/or RRC messaging. The RF sensing resource information may include multiple RF sensing resource configurations and lower level messaging (e.g., DCI, MAC-CE) may be utilized to dynamically switch between different RF sensing resource configurations. In an example, the RF sensing resource information may include TDD patterns to implicitly switch between different percentages of DL or UL RF sensing resources. For example, one of the plurality of wireless nodes may be configured (e.g., via SFI) to skip DL reception or UL transmission due to collisions between previously configured reference signals for DL or UL RF sensing. In an example, the method 1300 may iterate back to stage 1302 such that the received RF sensing information are the RF sensing measurement report messages 1218 based on the RF sensing resources provided at stage 1308. The number and/or size of the RF sensing measurement report messages 1218 may be limited by one or more threshold values (e.g., ‘x’) to reduce the signaling overhead associated with RF sensing operations. The threshold values may be based on a confidence level, a number of measurements, a SNR or RSRP value, a minimum range, and/or a number of taps in a channel impulse response measurement. The threshold values may be provided to the wireless nodes in the RF sensing resource information.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

Implementation examples are described in the following numbered clauses:

Clause 1. A method for configuring bistatic radio frequency sensing operations, comprising: receiving radio frequency sensing information from a plurality of wireless nodes; determining target parameters based at least in part on the radio frequency sensing information; determining a bistatic radio frequency sensing resource allocation based at least in part on the target parameters and a range to at least one of the plurality of wireless nodes; and providing radio frequency sensing resource information to the plurality of wireless nodes based on the bistatic radio frequency sensing resource allocation.

Clause 2. The method of clause 1, wherein the target parameters include range information for one or more targets.

Clause 3. The method of clause 1, wherein the radio frequency sensing information includes radio frequency signal measurements obtained by one or more wireless nodes in the plurality of wireless nodes.

Clause 4. The method of clause 3, wherein the radio frequency signal measurements include one or more of a signal-to-noise ratio (SNR), a reference signal received power (RSRP) value, a channel impulse response (CIR) value, and a carrier-to-error rate (CER).

Clause 5. The method of clause 1, wherein the radio frequency sensing information includes a fusion of radio frequency signal measurements obtained by one or more wireless nodes in the plurality of wireless nodes.

Clause 6. The method of clause 1, further comprising fusing the radio frequency sensing information received from two or more wireless nodes, and determining the target parameters based at least in part on fused radio frequency sensing information.

Clause 7. The method of clause 1, wherein determining the target parameters includes inputting the radio frequency sensing information into one or more artificial intelligence or machine learning models, and determining the target parameters based at least in part on an output of the one or more artificial intelligence or machine learning models.

Clause 8. The method of clause 1, wherein the bistatic radio frequency sensing resource allocation includes a higher percentage of uplink radio frequency sensing resources.

Clause 9. The method of clause 1, wherein the bistatic radio frequency sensing resource allocation includes a higher percentage of downlink radio frequency sensing resources.

Clause 10. The method of clause 1, wherein the bistatic radio frequency sensing resource allocation includes an equal mix of uplink radio frequency sensing resources and downlink radio frequency sensing resources.

Clause 11. The method of clause 1, wherein the radio frequency sensing resource information includes one or more threshold values configured to reduce a number of radio frequency sensing measurements reported by the plurality of wireless nodes.

Clause 12. The method of clause 11, wherein the one or more threshold values include one or more of a confidence value, a number of measurements, a signal-to-noise ratio value, a reference signal received power value, a minimum range value, and a number of taps for a channel impulse response measurement.

Clause 13. The method of clause 1, wherein the radio frequency sensing resource information is included in one or more system information blocks.

Clause 14. The method of clause 1, wherein the radio frequency sensing resource information includes multiple radio frequency resource configurations.

Clause 15. The method of clause 14, further comprising sending a message to one or more of the plurality of wireless nodes to activate one or more of the multiple radio frequency resource configurations.

Clause 16. The method of clause 1, further comprising receiving an on-demand request for radio frequency sensing from one or more of the plurality of wireless nodes.

Clause 17. The method of clause 1, further comprising receiving a capabilities message from one or more of the plurality of wireless nodes, wherein the capabilities message includes indications of a wireless nodes ability to perform radio frequency sensing operations.

Clause 18. An apparatus, comprising: at least one memory; at least one transceiver; at least one processor communicatively coupled to the at least one memory and the at least one transceiver, and configured to: receive radio frequency sensing information from a plurality of wireless nodes; determine target parameters based at least in part on the radio frequency sensing information; determine a bistatic radio frequency sensing resource allocation based at least in part on the target parameters and a range to at least one of the plurality of wireless nodes; and provide radio frequency sensing resource information to the plurality of wireless nodes based on the bistatic radio frequency sensing resource allocation.

Clause 19. The apparatus of clause 18, wherein the target parameters include range information for one or more targets.

Clause 20. The apparatus of clause 18, wherein the radio frequency sensing information includes radio frequency signal measurements obtained by one or more wireless nodes in the plurality of wireless nodes.

Clause 21. The apparatus of clause 20, wherein the radio frequency signal measurements include one or more of a signal-to-noise ratio (SNR), a reference signal received power (RSRP) value, a channel impulse response (CIR) value, and a carrier-to-error rate (CER).

Clause 22. The apparatus of clause 18, wherein the radio frequency sensing information includes a fusion of radio frequency signal measurements obtained by one or more wireless nodes in the plurality of wireless nodes.

Clause 23. The apparatus of clause 18, wherein the at least one processor is further configured to: fuse the radio frequency sensing information received from two or more wireless nodes; and determine the target parameters based at least in part on the fused radio frequency sensing information.

Clause 24. The apparatus of clause 18, wherein the at least one processor is further configured to: input the radio frequency sensing information into one or more artificial intelligence or machine learning models; and determine the target parameters based at least in part on an output of the one or more artificial intelligence or machine learning models.

Clause 25. The apparatus of clause 18, wherein the bistatic radio frequency sensing resource allocation includes a higher percentage of uplink radio frequency sensing resources.

Clause 26. The apparatus of clause 18, wherein the bistatic radio frequency sensing resource allocation includes a higher percentage of downlink radio frequency sensing resources.

Clause 27. The apparatus of clause 18, wherein the bistatic radio frequency sensing resource allocation includes an equal mix of uplink radio frequency sensing resources and downlink radio frequency sensing resources.

Clause 28. The apparatus of clause 18, wherein the radio frequency sensing resource information includes one or more threshold values configured to reduce a number of radio frequency sensing measurements reported by the plurality of wireless nodes.

Clause 29. The apparatus of clause 28, wherein the one or more threshold values include one or more of a confidence value, a number of measurements, a signal-to-noise ratio value, a reference signal received power value, a minimum range value, and a number of taps for a channel impulse response measurement.

Clause 30. The apparatus of clause 18, wherein the radio frequency sensing resource information is included in one or more system information blocks.

Clause 31. The apparatus of clause 18, wherein the radio frequency sensing resource information includes multiple radio frequency resource configurations.

Clause 32. The apparatus of clause 31, wherein the at least one processor is further configured to send a message to one or more of the plurality of wireless nodes to activate one or more of the multiple radio frequency resource configurations.

Clause 33. The apparatus of clause 18, wherein the at least one processor is further configured to receive an on-demand request for radio frequency sensing from one or more of the plurality of wireless nodes.

Clause 34. The apparatus of clause 18, wherein the at least one processor is further configured to receive a capabilities message from one or more of the plurality of wireless nodes, wherein the capabilities message includes indications of a wireless nodes ability to perform radio frequency sensing operations.

Clause 35. A non-transitory processor-readable storage medium comprising processor-readable instructions configured to cause one or more processors to configure bistatic radio frequency sensing operations, comprising code for: receiving radio frequency sensing information from a plurality of wireless nodes; determining target parameters based at least in part on the radio frequency sensing information; determining a bistatic radio frequency sensing resource allocation based at least in part on the target parameters and a range to at least one of the plurality of wireless nodes; and providing radio frequency sensing resource information to the plurality of wireless nodes based on the bistatic radio frequency sensing resource allocation.

Clause 36. An apparatus for configuring bistatic radio frequency sensing operations, comprising: means for receiving radio frequency sensing information from a plurality of wireless nodes; means for determining target parameters based at least in part on the radio frequency sensing information; means for determining a bistatic radio frequency sensing resource allocation based at least in part on the target parameters and a range to at least one of the plurality of wireless nodes; and means for providing radio frequency sensing resource information to the plurality of wireless nodes based on the bistatic radio frequency sensing resource allocation.

What is claimed is:

1. A method for configuring bistatic radio frequency sensing operations, comprising:
receiving radio frequency sensing information from a plurality of wireless nodes;
determining target parameters based at least in part on the radio frequency sensing information;
determining a bistatic radio frequency sensing resource allocation based at least in part on the target parameters and a range to at least one of the plurality of wireless nodes; and
providing radio frequency sensing resource information to the plurality of wireless nodes based on the bistatic radio frequency sensing resource allocation.

2. The method of claim 1, wherein the target parameters include range information for one or more targets.

3. The method of claim 1, wherein the radio frequency sensing information includes radio frequency signal measurements obtained by one or more wireless nodes in the plurality of wireless nodes.

4. The method of claim 3, wherein the radio frequency signal measurements include one or more of a signal-to-noise ratio (SNR), a reference signal received power (RSRP) value, a channel impulse response (CIR) value, and a carrier-to-error rate (CER).

5. The method of claim 1, wherein the radio frequency sensing information includes a fusion of radio frequency signal measurements obtained by one or more wireless nodes in the plurality of wireless nodes.

6. The method of claim 1, further comprising fusing the radio frequency sensing information received from two or more wireless nodes, and determining the target parameters based at least in part on fused radio frequency sensing information.

7. The method of claim 1, wherein determining the target parameters includes inputting the radio frequency sensing information into one or more artificial intelligence or machine learning models, and determining the target parameters based at least in part on an output of the one or more artificial intelligence or machine learning models.

8. The method of claim 1, wherein the bistatic radio frequency sensing resource allocation includes a higher percentage of uplink radio frequency sensing resources.

9. The method of claim 1, wherein the bistatic radio frequency sensing resource allocation includes a higher percentage of downlink radio frequency sensing resources.

10. The method of claim 1, wherein the bistatic radio frequency sensing resource allocation includes an equal mix of uplink radio frequency sensing resources and downlink radio frequency sensing resources.

11. The method of claim 1, wherein the radio frequency sensing resource information includes one or more threshold values configured to reduce a number of radio frequency sensing measurements reported by the plurality of wireless nodes.

12. The method of claim 11, wherein the one or more threshold values include one or more of a confidence value, a number of measurements, a signal-to-noise ratio value, a reference signal received power value, a minimum range value, and a number of taps for a channel impulse response measurement.

13. The method of claim 1, wherein the radio frequency sensing resource information is included in one or more system information blocks.

14. The method of claim 1, wherein the radio frequency sensing resource information includes multiple radio frequency resource configurations.

15. The method of claim 14, further comprising sending a message to one or more of the plurality of wireless nodes to activate one or more of the multiple radio frequency resource configurations.

16. The method of claim 1, further comprising receiving an on-demand request for radio frequency sensing from one or more of the plurality of wireless nodes.

17. The method of claim 1, further comprising receiving a capabilities message from one or more of the plurality of wireless nodes, wherein the capabilities message includes indications of a wireless nodes ability to perform radio frequency sensing operations.

18. An apparatus, comprising:
at least one memory;
at least one transceiver;
at least one processor communicatively coupled to the at least one memory and the at least one transceiver, and configured to:
receive radio frequency sensing information from a plurality of wireless nodes;
determine target parameters based at least in part on the radio frequency sensing information;
determine a bistatic radio frequency sensing resource allocation based at least in part on the target parameters and a range to at least one of the plurality of wireless nodes; and
provide radio frequency sensing resource information to the plurality of wireless nodes based on the bistatic radio frequency sensing resource allocation.

19. The apparatus of claim 18, wherein the radio frequency sensing information includes a fusion of radio frequency signal measurements obtained by one or more wireless nodes in the plurality of wireless nodes.

20. The apparatus of claim 18, wherein the at least one processor is further configured to:
fuse the radio frequency sensing information received from two or more wireless nodes; and
determine the target parameters based at least in part on fused radio frequency sensing information.

21. The apparatus of claim 18, wherein the at least one processor is further configured to:
input the radio frequency sensing information into one or more artificial intelligence or machine learning models; and
determine the target parameters based at least in part on an output of the one or more artificial intelligence or machine learning models.

22. The apparatus of claim 18, wherein the bistatic radio frequency sensing resource allocation includes a higher percentage of uplink radio frequency sensing resources.

23. The apparatus of claim 18, wherein the bistatic radio frequency sensing resource allocation includes a higher percentage of downlink radio frequency sensing resources.

24. The apparatus of claim 18, wherein the bistatic radio frequency sensing resource allocation includes an equal mix of uplink radio frequency sensing resources and downlink radio frequency sensing resources.

25. The apparatus of claim 18, wherein the radio frequency sensing resource information includes one or more threshold values configured to reduce a number of radio frequency sensing measurements reported by the plurality of wireless nodes.

26. The apparatus of claim 25, wherein the one or more threshold values include one or more of a confidence value, a number of measurements, a signal-to-noise ratio value, a reference signal received power value, a minimum range value, and a number of taps for a channel impulse response measurement.

27. The apparatus of claim 18, wherein the at least one processor is further configured to receive an on-demand request for radio frequency sensing from one or more of the plurality of wireless nodes.

28. The apparatus of claim 18, wherein the at least one processor is further configured to receive a capabilities message from one or more of the plurality of wireless nodes, wherein the capabilities message includes indications of a wireless nodes ability to perform radio frequency sensing operations.

29. A non-transitory processor-readable storage medium comprising processor-readable instructions configured to cause one or more processors to configure bistatic radio frequency sensing operations, comprising code for:
receiving radio frequency sensing information from a plurality of wireless nodes;
determining target parameters based at least in part on the radio frequency sensing information;
determining a bistatic radio frequency sensing resource allocation based at least in part on the target parameters and a range to at least one of the plurality of wireless nodes; and
providing radio frequency sensing resource information to the plurality of wireless nodes based on the bistatic radio frequency sensing resource allocation.

30. An apparatus for configuring bistatic radio frequency sensing operations, comprising:
means for receiving radio frequency sensing information from a plurality of wireless nodes;
means for determining target parameters based at least in part on the radio frequency sensing information;
means for determining a bistatic radio frequency sensing resource allocation based at least in part on the target parameters and a range to at least one of the plurality of wireless nodes; and
means for providing radio frequency sensing resource information to the plurality of wireless nodes based on the bistatic radio frequency sensing resource allocation.
